(19) United States
(12) Patent Application Publication
(10) Pub. No.: US 2008/0077750 A1
(43) Pub. Date: Mar. 27, 2008

(54) Memory block fill utilizing memory controller

(76) Inventor: Subhankar Panda, Sungai Nibong (MY)

Correspondence Address: RYDER IP LAW;C/O INTELLEVATE, P. O. BOX 52050, MINNEAPOLIS, MN, 55402, US

(21) Appl. No.: 11/527,800

(22) Filed: Sep. 27, 2006

(51) Int. Cl. G06F 13/00

(52) U.S. Cl. 711/154

(57) ABSTRACT

In general, in one aspect, the disclosure describes a processor having a central processing unit, a memory controller unit and a shared bus. The CPU can execute software programs to control operation of the processor and can initiate a memory write operation. The memory controller unit includes at least one register to capture parameters related to the memory write operation. The memory write operation parameters are written to the at least one register in said memory controller unit. The memory controller unit utilizes the memory write operation parameters to perform the memory write operation.

### BACKGROUND

Processors (e.g., input/output (I/O) processors, network processors) perform various functions. A central processing unit (CPU) within the processor controls the operation of the processor by executing various software programs loaded onto the CPU. Some of the functions called for in the software will entail processing of data while other ftnctions will not. Utilizing the CPU to perform functions that do not require processing would unnecessarily tie up processing resources. For example, the transfer of data among periphery (e.g., from I/O to memory, memory to I/O, memory to memory) does not require processing of the data and accordingly these tasks need not be performed by the CPU. Direct memory access (DMA) functional units may be utilized to handle the transfer of data. The software running on the CPU may offload these non-processing (e.g., data transfer) tasks to the DMA. The DMA utilizes a shared bus to transfer the data.

The software running on.the CPU may also utilize the DMA to perform memory block fill operations (write specific patterns of data to specific blocks of memory). For example, the software running on the CPU associated with a memory device (e.g., a random array of independent disks (RAID) device connected to the system the processor is located in) may determine that a memory block fill should be initiated (e.g., start-up, error recovery). The memory block fill may be utilized by the memory device for internal purposes (e.g., initialization, test). The software running on the CPU retrieves a memory mapped descriptor with the start address, length and data pattern from: memory and forwards to the DMA and initializes the DMA to start a memory fill operation. Based on the memory mapped descriptor, the DMA utilizes the shared bus to write the data pattern to the appropriate memory locations. The DMA controls the shared bus for the amount of time it takes to write the data pattern to the number of memory addresses in the block (the length).

### BRIEF DESCRIPTION OF THE DRAWINGS

The features and advantages of the various embodiments will become apparent from the following detailed description in which:

FIG. 1 illustrates a simplified functional block diagram of an example system, according to one embodiment; and

FIG. 2 illustrates a simplified functional block diagram of an example processor, according to one embodiment.

### DETAILED DESCRIPTION

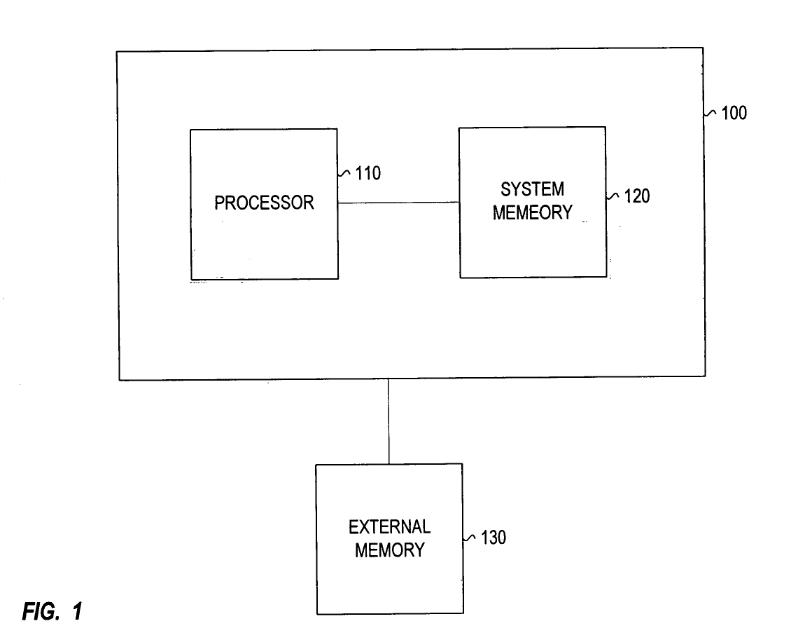

FIG. 1 illustrates a simplified fimctional block diagram of an example system 100. The system includes a processor 110 (e.g., I/O processor, network processor) and system memory 120 (e.g., dynamic random access memory (DRAM), static RAM (SRAM)). The system memory 120 may include the quad data rate (QDR) family of SRAM and the dual data rate (DDR) family of DRAM. The system 100 may also be connected to an external memory device 130 (e.g., random array of independent disks (RAID)). On certain occasions, the processor 110 may determine that a memory block fill operation should be performed (e.g., for the system memory 120 or the external memory 130). The processor 110 may retrieve a memory mapped descriptor with the start address, length and data pattern for the appropriate memory 120/130 and then utilize the memory mapped descriptor to write the appropriate data pattern to the appropriate memory addresses.

By way of example, assume as part of the memory block fill operation the memory 120/130 will have 4 byte words containing all 0s written to the first 16 memory addresses (0x00000000-0x00000010). A memory mapped descriptor may be retrieved that may include a start address of 0x00000000, a length of 0x10, and a pattern of 0x00000000. The processor 110 may then write 0x00000000 to each of the appropriate addresses in the memory 120/130. The memory block fill operation initiated for the memory 120/130 may be the same for all circumstance or may vary depending on circumstances (e.g., initial start-up vs. error recovery).

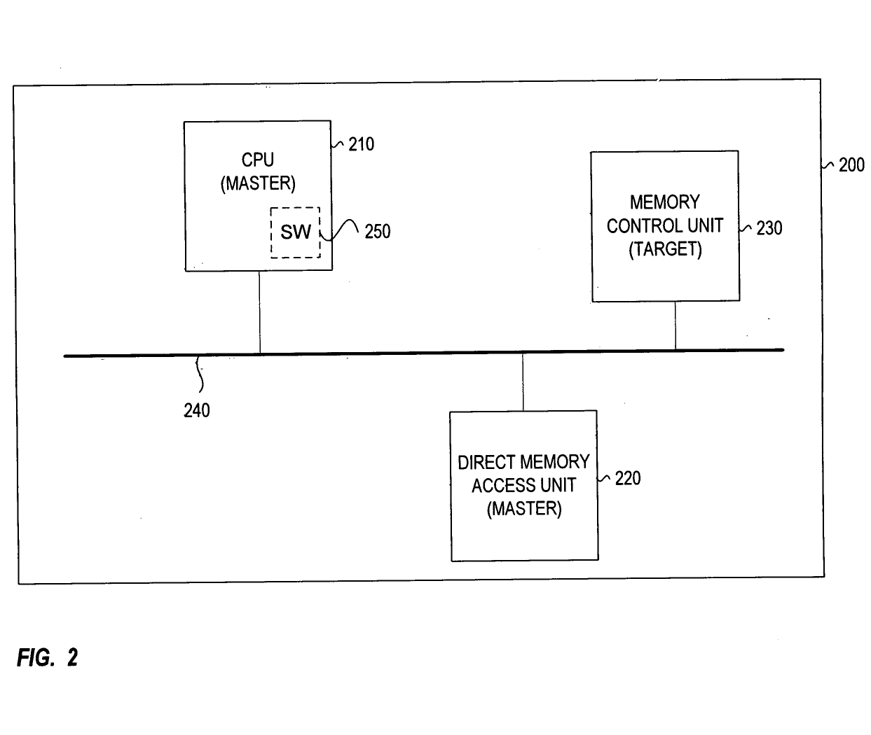

FIG. 2 illustrates a simplified,ftnctional block diagram of an example processor 200 (e.g., processor 110 of FIG. 1). The processor 200 includes a central processing unit (CPU) 210, a direct memory access unit (DMA) 220, and a memory controller unit (MCU) 230, all connected via a shared bus 240. The CPU 210 and the DMA 220 are masters and the MCU 230 is a target. Any master that wants to perform a transaction on the bus 240 requests access to the bus 240. The arbitration between requests is controlled by an arbitration unit (not illustrated) that is an integral part of the shared bus 240. Once a request is granted (a grant is issued) the master can perform one or more transactions on the bus.

The CPU 210 may control the operation of the processor 200 and perform various processing operations that may be controlled by executing various software programs 250. The DMA 220 may be utilized to transfer data not requiring processing (e.g., from I/O to memory, memory to I/O, memory to memory) and to initiate the writing of data to memory (e.g., block memory fill). The MCU 230 may be connected to and control various physical (e.g., semiconductor) memory devices (e.g., 120 of FIG. 1).

The software 250 running on the CPU 210 associated with a memory device (either system or external) will determine that a memory block fill needs to be performed. The CPU 210 will retrieve a memory mapped descriptor including the start address, length and data pattern from memory and forward it to the DMA 220 and initialize the DMA to initiate the write (memory block fill) operation. The DMA 220 may request the bus 240 for the write operation and once the bus 240 is granted the DMA 220 may write the data pattern to the starting memory address in system memory (e.g., 120) and then continue to write the data pattern to succeeding memory addresses for the length of the write (e.g., memory address 0x00000000-0x00000010).

It should be noted that the processor 200 likely does not include a controller for an external memory device (e.g., 130) and as such any data to be written to the external memory device may utilize the MCU 230 and the system memory. Getting the data from the system memory to the external memory may be implemented in numerous ways that will not be described herein. However, all of the various methods are within the current scope of the various embodiments described herein.

If the DMA 220 actually wrote the pattern to each of the appropriate memory addresses in the system memory the DMA 220 would control the bus 240 for the amount of time it takes to write that number of words. For example, if 16 words are to be written to the system memory, the bus 240 would be occupied for the amount of time that it takes to write 16 words. Requiring the DMA 220 to control the bus 240 for this amount of time means that the bus 240 will not be available for transactions of other master processors (e.g., CPU 210). Moreover, a request for this amount of bus resources may result in a slower grant if the bus 240 is not available for that amount of time due to the needs of other masters.

Enabling the data to be written to the system memory off-line (not utilizing the shared bus 240) would free up the bus resources. One way to write the data to the system memory off-line would be to utilize the MCU 230 that is already connected to and in communication with the system memory. The MCU 230 may be modified to include additional logic to handle writing the data pattern to the appropriate memory addressees (memory block fill operations). Additionally, the MCU 230 may be modified to include a set of registers for capturing the start address, the length and data pattern for the memory fill operation (memory mapped descriptor).

As the software 250 running on the CPU 210 is already forwarding the memory mapped descriptor to the DMA 220, the DMA 220 may be modified to forward the memory mapped descriptor (starting address, length data pattern) to the MCU 230 so that no changes would be required to the software (e.g., RAID software). According to this embodiment, when the CPU 210 initiates a memory block fill operation the CPU 210 will retrieve the memory mapped descriptors and forward to the DMA 220 and initialize the memory block fill operation in the DMA 220. The DMA 220 will request bus resources for performing writes of the parameters from the memory mapped descriptor to the registers in the MCU 230. Once the bus 240 is granted the DMA 220 will control the bus 240 while it writes the appropriate data to the appropriate register in the MCU 230. Accordingly, the DMA 220 will maintain the bus 240 for only the amount of time that it takes to write to the three registers in the MCU 230. The bus 240 is not needed for the entire time it takes to perform the entire memory block fill operation.

Once the MCU 230 has all the registers filled it may begin to write the data pattern to the memory (perform memory block fill operation) off-line from the bus 240. The MCU 230 may be configured to initiate the off-line write immediately after all the registers are filled. Alternatively, the MCU 230 may be configured to initiate the off-line write after a certain register (e.g., length) is filled as that may be the last register to be filled (order of the other two may not matter).

The internal write operations of the MCU 230 may be implemented in numerous ways. The various MCU 230 internal write operations will not be described herein. However, all of the various methods are within the current scope of the various embodiments described herein.

Implementing the memory block fill operation as described above, where the DMA 230 receives the memory mapped descriptor from the software 250 and writes this data to the registers in MCU 230 allows the software 250 running on the CPU 210 associated with memory devices to continue to operate in the same fashion. That is, a processor 200 implementing the off-loading of the memory block fill operations from the DMA 220 to the MCU 230 in this fashion is backward compatible with current software 250 running on the CPU 210 (e.g., RAID software).

However, implementing the off-loading of the memory block fill operations in this fashion may not be the most efficient. That is, the memory mapped descriptors are retrieved from memory by the CPU 210, the CPU 210 then forwards them to the DMA 220, and the DMA 220 then forwards the parameters contained therein to the registers in the MCU 230. According to one embodiment, the software 250 running;on the CPU 210 may be modified to forward the memory mapped descriptors (or the parameters contained therein) directly to the registers in the MCU 230.

The embodiments described above were discussed with specific reference to memory block fill operations but are in no way limited thereto. For example, any software application 250 running on the CPU that utilizes standard library calls that entail the CPU 210 (or DMA 220) writing data to a certain block of addresses (e.g., memset) can be replaced with the CPU 210 (or DMA 220) writing the parameters to the MCU 230 and the MCU 230 performing the write as discussed above.

The embodiments described above were discussed with specific reference to systems having a processor (e.g., 110) and system memory (e.g., 120) but are in no way limited thereto. For example, the various embodiments could be applied to systems on a chip.

The embodiments described above were discussed with reference to memory writes (e.g., memory block fill to RAID) but are not limited thereto. For example, other periphery devices may be connected to the system and the software being executed on the CPU for these devices may determine that data should be written to the periphery. As it is likely that a controller for the periphery is not available in the processor (much like there is likely no RAID controller) the data may be written to the system memory via the MCU and then transferred from the MCU to the periphery device. The writing of data to the memory device via the MCU may be performed as discussed above where the CPU or DMA writes parameters to registers in the MCU and the MCU writes the actual data off-line of the shared bus.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

Different implementations may feature different combinations of hardware, firmware, and/or software. It may be possible to implement, for example, some or all components of various embodiments in software and/or firmware as well as hardware, as known in the art. Embodiments may be implemented in numerous types of hardware, software and firmware known in the art, for example, integrated circuits, including ASICs and other types known in the art, printed circuit broads, components, etc.

The various embodiments are intended to be protected broadly within the spirit and scope of the appended claims.

What is claimed:

1. A processor comprising
a central processing unit to execute software programs to control operation of the processor, wherein said central processing unit can initiate a memory write operation;
a memory controller unit including at least one register to capture parameters related to the memory write operation; and
a shared bus, wherein the memory write operation parameters are written to the at least one register in said memory controller unit, and wherein said memory controller unit utilizes the memory write operation parameters to perform the memory write operation.

2. The processor of claim 1, wherein said central processing unit utilizes said shared bus to write the memory write operation parameters to the at least one register in said memory controller unit.

3. The processor of claim 1, further. comprising a direct memory access unit to receive the memory write operation parameters from said central processing unit, wherein said direct memory access unit utilizes said shared bus to write the memory write operation parameters to the at least one register in said memory controller unit.

4. The processor of claim 1, wherein said memory controller unit performs the memory write operation off-line from the shared bus.

5. The processor of claim 1, wherein amount of time said shared bus is required to complete the memory write operation is amount of time it takes to write the memory block fill parameters to said memory controller unit.

6. The processor of claim 1, wherein the memory write operation parameters include starting address, length and data pattern.

7. The processor of claim 6, wherein the at least one register includes a starting address register, a length register and a data pattern register.

8. The processor of claim 1, wherein the memory device is semiconductor memory.

9. The processor of claim 1, wherein the memory device is a hard disk.

10. The processor of claim 1, wherein the memory write operation is any write operation that entails filing a certain range of addresses with same data.

11. A method comprising
initiating a memory write operation in a central processing unit;
writing memory write operation parameters to a memory controller unit via a shared bus; and
writing data from the memory controller unit to appropriate memory address locations in a memory device based on the memory write operation parameters, wherein said writing is performed off-line from the shared bus.

12. The method of claim 11, wherein said writing memory write operation parameters includes writing the memory write operation parameters from the central processing unit to a direct memory access unit and from the direct memory access unit to at least one register in the memory controller unit.

13. The method of claim 11, wherein said writing data includes writing a specific data pattern to the memory device based on the memory write operation parameters.

14. The method of claim 11, wherein a shared bus is only required for amount of time it takes to write the memory write operation parameters to the memory controller unit in order to complete the memory write operation.

15. The method of claim 11, wherein the memory write operation parameters include starting address, length and data pattern and said writing memory block fill parameters includes writing the starting address to a starting address register in the memory controller unit, writing the length to a length register in the memory controller unit, and writing the data pattern to a data pattern register in the memory controller unit.

16. The method of claim 11, wherein the memory write operation is a memory block fill operation.

17. The method of claim 11, wherein the memory write operation is a standard library call for writing data to a certain block of addresses.

18. A system comprising
a processor having
a central processing unit (CPU);
a direct memory access unit (DMA);
a memory controller unit (MCU) including a starting address register, a length register and a data pattern register; and
a shared bus;
semiconductor memory; and
a redundant array of independent disks (RAID) memory device, wherein when RAID software running on the CPU determines a memory block fill operation is in order the CPU retrieves a memory mapped descriptor including starting address, length and data pattern and initiates the memory block fill operation, wherein the starting address, the length and the data pattern are written to the starting address register, the length register and the data pattern register respectively via the shared bus, and wherein the MCU then writes the data pattern to appropriate addresses in the semiconductor memory off-line from the shared bus.

19. The system of claim 18, wherein the RAID software provides the memory mapped descriptor to the DMA and the DMA utilizes the shared bus to write the starting address, the length and the data pattern to the starting address register, the length register and the data pattern register respectively.

20. The system of claim 18, wherein the RAID software utilizes the shared bus to write the starting address, the length and the data pattern from the CPU to the starting address register, the length register and the data pattern register respectively.
